(19) United States
(12) Patent Application Publication
(10) Pub. No.: US 2020/0068863 A1
(43) Pub. Date: Mar. 5, 2020

(54) FLY FISHING STRIKE INDICATOR HAVING MULTIPLE TRAPPED AIR ENCLOSURES

(71) Applicant: Stephen William Cunic, Bethlehem, PA (US)

(72) Inventor: Stephen William Cunic, Bethlehem, PA (US)

(21) Appl. No.: 16/116,457

(22) Filed: Aug. 29, 2018

(51) Int. Cl. A01K 93/00; A01K 91/03

(52) U.S. Cl. CPC A01K 93/00; A01K 91/03

(57) ABSTRACT

The strike indicator includes a float formed from a plurality of sealed air enclosures, each of the plurality of sealed air enclosures including an outer membrane, each of the plurality of sealed air enclosures being entirely offset from the center of the float. The strike indicator also includes a line attachment device configured to secure a fishing line therein, the line attachment device being attached to the float and located in a center of the float between the plurality of sealed air enclosures. The line attachment device includes a threaded bolt having an L-shaped notch formed in its shaft, wherein a fishing line can be inserted in the notch to secure the strike indicator to the fishing line.

### BACKGROUND

A strike indicator, often colloquially called a “bobber,” is a buoyant fishing accessory that is attached to a fishing line and, when cast in water, floats above the water surface and in view of the angler. In so doing, the strike indicator suspends an attached bait or weight at a predetermined depth on the fishing line. The strike indicator also helps the angler determine the depth of the water in which s/he is fishing, and when a fish bites the fishing line, it pulls the strike indicator either along or underneath the water surface, thereby notifying the angler of the bite.

One type of strike indicator is a trapped air indicator, which comprises a closed-cell hollow float that seals air inside the float to achieve buoyancy. Trapped air indicators are popular due to their predictable buoyancy, visibility, and reusability. Trapped air indicators can also be customized with respect to size and buoyancy for different water types.

Most trapped air indicators in the art are made from a rigid plastic, such as high-density polyethylene (HDPE), that is durable and has low permeability to ensure that air and water do not escape or enter the indicator. Unfortunately, such indicators tend to have hard surfaces that, when contacting the water surface upon being cast, create significant disturbances in the water that frighten fish away from the point of contact. In such circumstances, such indicators are not recommended for fishing in clear, calm, or shallow water.

Strike indicators in the art that are used for angling in clear, shallower water tend to be made from porous materials, such as foam or yarn, and cause fewer disturbances in the water when used. Unfortunately, these strike indicators can only be used for a brief period of time before they become ineffective, as their tendency to soak up water will cause them to lose buoyancy, making them unable to continuously suspend a line leader at a predetermined depth. In such circumstances, the angler must remove the saturated indicator from the water and either dry it or apply additional floatant material to it to give the indicator buoyancy. Such activities take time away from the activity of fishing.

In the foregoing circumstances, there is a desire for a strike indicator that achieves the consistency and longevity of trapped air indicators and the soft landing, low noise features of foam or yarn indicators.

### SUMMARY

In view of the foregoing background, an innovative strike indicator is provided. The strike indicator includes a float having a plurality of sealed air enclosures, each of the plurality of sealed air enclosures including an outer membrane and being entirely offset from the center of the float; and a line attachment device located in a center of the float such that the line attachment device does not intersect with any one of the plurality of sealed air enclosures. In one embodiment, the strike indicator further includes a first film and a second film to which the plurality of sealed air enclosures is attached, wherein the first film is located along a bottom portion of the plurality of sealed air enclosures and the second film is located along a top portion of the plurality of sealed air enclosures. In one embodiment, the line attachment device comprises a bolt having a base and a threaded shaft, a threaded nut configured to engage with the threaded shaft of the bolt, and a notch formed in the threaded shaft that spans the width of the threaded shaft, wherein the threaded shaft has a base end, a free end opposite the base end, a center axis, and an outer circumference, and the notch extends from the outer circumference of the threaded shaft to a corner point at the center axis of the threaded shaft and from the corner point to the base end of the threaded shaft.

A method of attaching the strike indicator described above is also provided. The method includes positioning the threaded nut on the threaded shaft between the free end and the notch, inserting a fishing line in the notch and between at least two of the plurality of sealed air enclosures, and rotating the threaded nut about the threaded shaft such that the threaded nut moves along the threaded shaft toward the base until the fishing line is compressed between the threaded nut and the base.

### BRIEF DESCRIPTION OF THE DRAWINGS

For a more complete understanding of the present invention, reference is made to the following detailed description of embodiments considered in conjunction with the accompanying drawings, in which:

FIG. 1 is a top perspective view of a strike indicator constructed in accordance with an embodiment of the present invention;

FIG. 2 is an exploded view of the strike indicator shown in FIG. 1;

FIG. 3 is a top plan view of the float of the strike indicator shown in FIGS. 1 and 2; and

FIG. 4 is a perspective view of the line attachment device of the strike indicator shown in FIGS. 1 and 2.

### DETAILED DESCRIPTION

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that embodiment, but should not be interpreted to preclude the presence or addition of additional features, components, operations, and/or groups thereof.

The following disclosure is intended to be read in connection with the accompanying drawings, which are to be considered part of the entire written description of the invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise, and includes terms such as “directly” coupled, secured, etc. The term “operatively coupled” is such an attachment, coupling, or connection that allows the pertinent structures to operate as intended by virtue of that relationship.

In this application, “impermeable” refers to a material's ability to prevent diffusion of liquid or gas through the material at room temperature (i.e., between 15° C. and 25° C.).

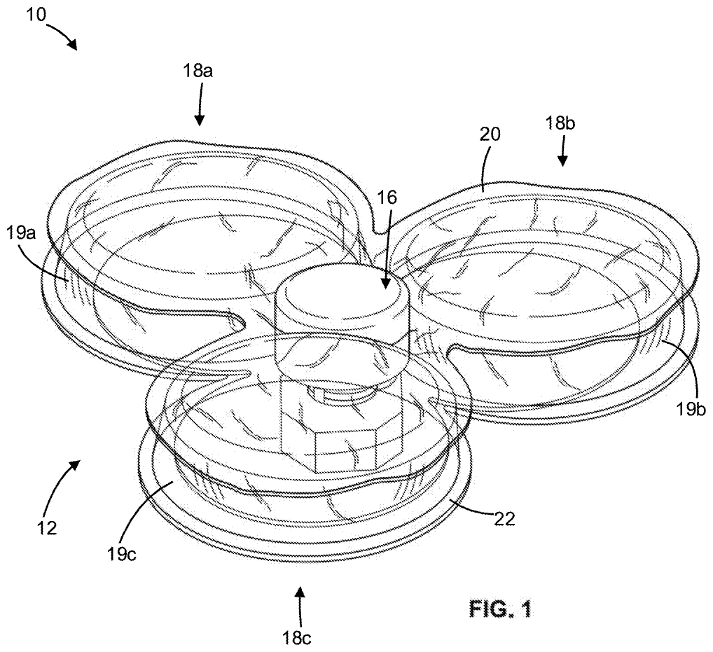

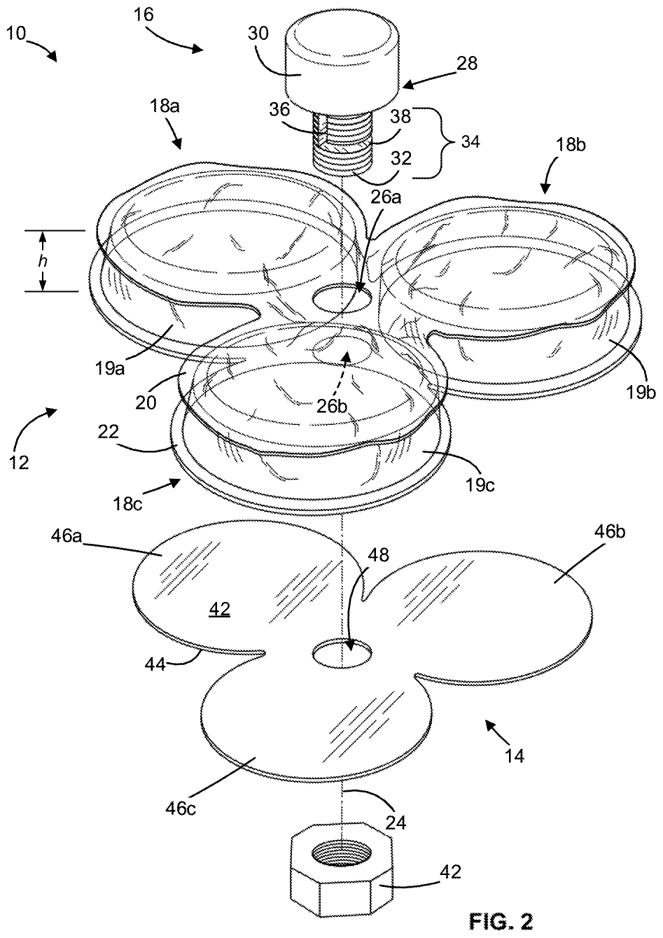

Turning now to FIGS. 1 and 2, a strike indicator 10 for use in fly fishing and other types of angling is shown. The strike indicator 10 includes a float 12, a support panel 14, and a line attachment device 16. The float 12 comprises a plurality of sealed air enclosures 18a-c that are entirely offset from the center of the float 12 and are attached to each other by a top film 20 and a bottom film 22. The top film 20 is connected to the top surfaces of the sealed air enclosures 18a-c and the bottom film 22 is connected to the bottom surfaces of the sealed air enclosures 18a-c. Both the top film 20 and the bottom film 22 span the distances between the sealed air enclosures 18a-c and serve to provide structure to the float 12.

The sealed air enclosures 18a-c have membranes 19a-c that provide air-tight enclosures of sufficient volume to give the float 12 buoyancy. The sealed air enclosures 18a-c also have an internal air pressure equal to atmospheric pressure to allow for the float 12 to be capable of absorbing the shock of contacting water without bursting or causing significant disturbances in the water. The membranes 19a-c, the top film 20, and the bottom film 22 of the float 12 are made from a light, flexible, water-impermeable material, preferably a thermoplastic having a thickness less than or equal to 0.2 mm (0.008 inches) and a Young's Modulus between 100 MPa and 900 MPa. More preferably, the material of the float 12 is low-density polyethylene, having a thickness less than or equal to 0.1 mm (0.004 inches) and a Young's Modulus between 100 MPa and 400 MPa.

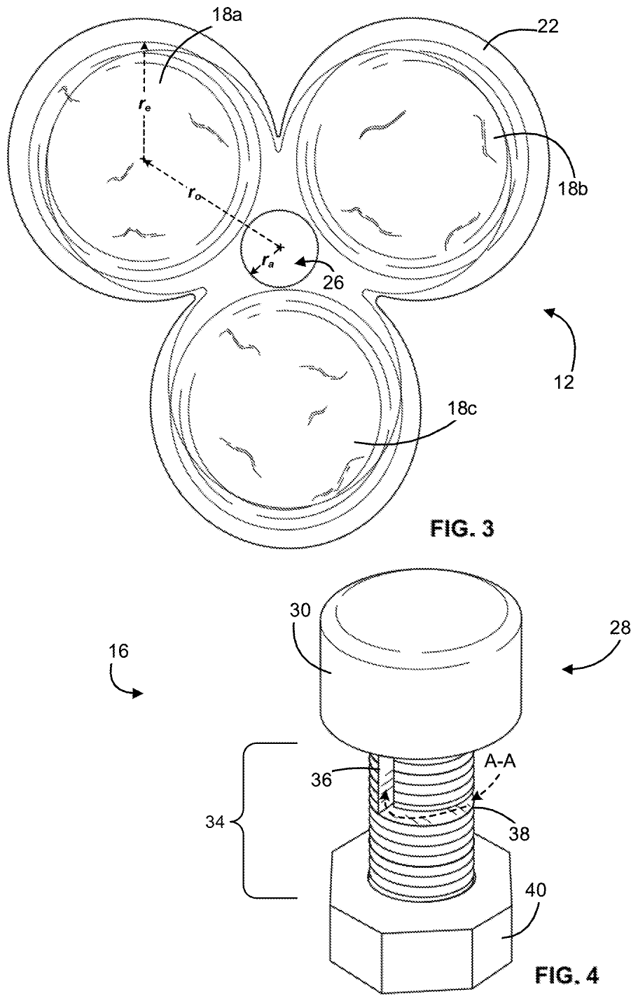

As seen in FIGS. 2 and 3, the float 12 has an axis 24 that vertically extends through the center of the float 12 between the sealed air enclosures 18a-c. An axial aperture 26 extends along axis 24 and through the top film 20 and the bottom film 22 (see top axial aperture 26a and bottom axial aperture 26b) and has an aperture radius rₐ that is sized and shaped to accommodate the line attachment device 16. This positioning of the line attachment device 16 provides balance to the float 12, as the amount of buoyancy provided by the sealed air enclosures 18a-c on one side of the line attachment device 16 is balanced by the buoyancy provided by the sealed air enclosures 18a-c on the opposing side of the line attachment device 16. Such balancing enables an angler to have a straighter cast, which prevents tangles in the line and allows the attached fly/bait/hook to quickly reach the desired water depth drag-free.

Still referring to FIGS. 2 and 3, each of the sealed air enclosures 18a-c has a vertical height h, an enclosure radius rₑ, and an offset radius rₒ equal to the distance from the center of the aperture 26 to the center of the sealed air enclosure (e.g., sealed air enclosure 18a). The offset radius rₒ must be greater than the combined lengths of the enclosure radius rₑ and the aperture radius rₐ to ensure that the sealed air enclosure 18a does not intersect with the aperture 26. In addition, to ensure that the float 12 provides sufficient buoyancy to keep the line attachment device 16, and therefore the line, substantially vertical while resting on the water, the offset radius rₒ of each of the sealed air enclosures is sized to be greater than or equal to the height of each of the sealed air enclosures 18a-c. In one embodiment, the enclosure radius rₑ is also sized to be greater than or equal to the vertical height h of each of the sealed air enclosures 18a-c.

Turning now to FIG. 4, the line attachment device 16 comprises a threaded bolt 28 having a base end 30 and an opposing free end 32, with a threaded shaft 34 extending therebetween. Within the threaded shaft 34 is a line leader notch 36 that begins at a lateral end 38 of the threaded shaft 34 and extends to the center axis of the threaded bolt 28. The line leader notch 36 then extends through the threaded shaft 34 along the center axis of the threaded bolt 28 to the base end 30, creating an L-shaped notch in the threaded bolt 28 through which a line leader may be inserted. The line attachment device 16 also includes a threaded nut 40 that threadably engages with the free end 32 of the threaded bolt 28. In one embodiment, the threaded bolt 28 and threaded nut 40 are made from nylon. Other embodiments of the threaded bolt 28 and threaded nut 40 are made from acrylic, HDPE, polypropylene, polyvinyl chloride (PVC), and other thermoplastics, as well as rubber.

To attach the strike indicator 10 to a line leader, the threaded nut 40 is positioned on the threaded shaft 34 between the free end 32 and the line leader notch 36, and the line leader is inserted into the line leader notch 36 along line A-A, positioning the line leader within the line leader notch 36 against the base end 30. The threaded nut 40 is then rotated along the threaded shaft 34 toward the base end 30, eventually clamping the line leader between the threaded nut 40 and the base end 30 to secure the line leader to the line attachment device 16. When an angler wishes to remove the strike indicator 10, the threaded nut 40 is rotated in the opposite direction toward the free end 32 until the threaded nut 40 has surpassed the line leader notch 36. This allows the angler to remove the strike indicator 10 from the line leader without removing the threaded nut 40 from the threaded bolt 28 entirely, thereby reducing the risk of losing the threaded nut 40.

Referring back to FIGS. 1 and 2, the support panel 14 serves as both a backing for the float 12 and a slight weight to help orient the strike indicator 10 in an upright position while in water, thereby allowing the line leader to have a more vertical orientation under the water. The support panel 14 has a top surface 42 positioned adjacent to the float 12, a bottom surface 44, a clover-leaf shape with a plurality of petals 46a-c that correspond in number, size, and shape to the plurality of sealed air enclosures 18a-c, and a central aperture 48 that is coaxially aligned with the top and bottom axial apertures 26a, 26b. In one embodiment, the support panel 14 is transparent or translucent so that its appearance does not scare away fish. In another embodiment, the support panel 14 is colored to assist the angler in identifying where the strike indicator is on the water, as well as to disguise its presence to fish.

In addition to the ones discussed above, the strike indicator 10 offers many advantages over trapped air indicators of the prior art. For example, when attached to a line, the float 12 surrounds fishing line to balance its mass around all sides of the line. As a result, the drag experienced by the strike indicator 10 when cast is substantially balanced around all sides of the line. This enables the float 12 of the strike indicator 10 to act as a parachute for the fly/bait/lure when it falls to the water, which reduces the velocity of the strike indicator and minimizes disturbances in the water when the strike indicator 10 contacts the water, thereby reducing the chances of scaring away fish.

In addition, the material of the float 12 allows the strike indicator 10 to be low weight, highly flexible, and water impermeable, all of which create different advantages. The low weight of the strike indicator 10 allows the fly/bait/lure to be the heavier component of the fishing line such that the weight of the two combined is concentrated at the forward end of the fishing line, which keeps the strike indicator 10 from creating kinks in the line and/or causing the line to become tangled or knotted. The high flexibility of the float 12 allows the strike indicator 10 to land softly on water, as contact with the water will create more disturbances within the float 12 itself than with the water's surface. The water impermeability of the float 12 prevents the strike indicator 10 from absorbing water, which allows the strike indicator 10 to float on water and enables the angler to manipulate the strike indicator 10 on the water more easily (such as when mending or recasting). Furthermore, the shape and transparency of the float 12 operates as camouflage by allowing the strike indicator 10 to have the appearance of water bubbles floating along the water's surface, which reduces the likelihood that the strike indicator 10 will scare away fish during use.

Many modifications can be made to the strike indicator 10 without departing from the present invention. For example, while the embodiment shown in FIGS. 1 and 2 feature three sealed air enclosures 18a-c, the float 12 may have as few as two sealed air enclosures and as many sealed air enclosures as a user desires, so long as the line attachment device 16 is located in the middle of the float 12 between all the sealed air enclosures. Multiple floats 14 can also be stacked on top of each other to achieve increased buoyancy. In addition, while the threaded nut 40 shown in FIG. 4 has a hexagonal shape to assist in manipulation, the threaded nut 40 may have alternative shapes, such as square or circular. In addition, while the base end 30 of the threaded bolt 28 is circular in shape, the base end 30 may also have alternative shapes, such as square or hexagonal. All such modifications are considered to be within the scope of the present invention.

All examples and conditional language recited herein are intended for pedagogical purposes to aid the reader in understanding the principles of the present invention and the concepts contributed by the inventor in furthering the art. As such, they are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It is to be understood that the embodiments described herein are merely exemplary and that a person skilled in the art may make many variations and modifications without departing from the spirit and scope of the invention. All such variations and modifications are intended to be included within the scope of the invention, as defined by the following claims.

1. A strike indicator for use with a fishing line, comprising:
a float having a plurality of sealed air enclosures, each of the plurality of sealed air enclosures including an outer membrane and being entirely offset from a center of the float; and
a line attachment device located in the center of the float such that the line attachment device does not intersect with any one of the plurality of sealed air enclosures.

2. The strike indicator of claim 1, wherein each of the plurality of sealed air enclosures has a vertical height and an offset radius, wherein the offset radius is greater than or equal to the vertical height.

3. The strike indicator of claim 1, further comprising a first film to which the plurality of sealed air enclosures are attached, the first film spanning a distance between each of the plurality of sealed air enclosures and each adjacent one of the plurality of sealed air enclosures.

4. The strike indicator of claim 3, wherein the first film includes a first aperture through which the line attachment device is inserted, the first aperture having a perimeter that does not intersect with any one of the plurality of sealed air enclosures.

5. The strike indicator of claim 3, further comprising a second film to which the plurality of sealed air enclosures are attached, the second film spanning the distances between each of the plurality of sealed air enclosures and each adjacent one of the plurality of sealed air enclosures, the second film including a second aperture through which the line attachment device is inserted, the second aperture having a perimeter that does not intersect with any one of the plurality of sealed air enclosures.

6. The strike indicator of claim 5, wherein the first film is located along a bottom portion of the plurality of sealed air enclosures and the second film is located along a top portion of the plurality of sealed air enclosures.

7. The strike indicator of claim 1, wherein the plurality of sealed air enclosures are made from a translucent or transparent material.

8. The strike indicator of claim 1, wherein the outer membrane of each of the plurality of sealed air enclosures has a thickness that is less than or equal to 0.2 mm.

9. The strike indicator of claim 8, wherein the material of the outer membrane has a Young's Modulus between 100 MPa and 800 MPa.

10. The strike indicator of claim 8, wherein the outer membrane is made from low density polyethylene.

11. The strike indicator of claim 1, wherein the line attachment device comprises a bolt having a base and a threaded shaft, a threaded nut configured to engage with the threaded shaft of the bolt, and an L-shaped notch formed in the threaded shaft that spans a width of the threaded shaft.

12. The strike indicator of claim 11, wherein the threaded shaft has a base end, a free end opposite the base end, a center axis, and an outer circumference; and wherein the L-shaped notch extends from the outer circumference of the threaded shaft to the center axis of the threaded shaft and along the center axis of the threaded shaft to the base end of the threaded shaft.

13. The strike indicator of claim 11, wherein the threaded nut is hexagonal in shape.

14. A strike indicator for use with a fishing line, comprising:
a float including a center axis, at least one sealed air enclosure, and an aperture located in a center of the float and coaxially aligned with the center axis, the aperture having a perimeter that does not intersect with the at least one sealed air enclosure; and
a line attachment device located in the aperture of the float.

15. The strike indicator of claim 14, wherein the at least one sealed air enclosure has an enclosure vertical height and an enclosure radius, wherein the enclosure radius is greater than or equal to the enclosure vertical height.

16. The strike indicator of claim 14, wherein the at least one sealed air enclosure is made from a translucent or transparent material.

17. The strike indicator of claim 14, wherein the at least one sealed air enclosure is made from a material having a thickness that is less than or equal to 0.2 mm.

18. A method of attaching a strike indicator to a fishing line, the strike indicator including a float and an attachment device, the attachment device comprising a threaded nut and a threaded bolt, the threaded bolt having a center axis, a base, and a threaded shaft, the threaded shaft extending from the base to a free end, the threaded shaft including an L-shaped notch formed therein that extends from an outer circumference of the threaded shaft to the center axis and along the center axis to the base, the method comprising:
(a) positioning the threaded nut on the threaded shaft between the free end and the notch;
(b) inserting a fishing line in the L-shaped notch; and
(c) rotating the threaded nut about the threaded shaft such that the threaded nut moves along the threaded shaft toward the base.

19. The method of claim 18, wherein the strike indicator includes a float having a plurality of sealed air enclosures, and the method further comprises:
(d) inserting the fishing line between at least two of the plurality of sealed air enclosures.

20. The method of claim 18, wherein step (c) includes rotating the threaded nut until the fishing line is clamped between the threaded nut and the base.
